(19) United States
(12) Patent Application Publication
(10) Pub. No.: US 2010/0313465 A1
(43) Pub. Date: Dec. 16, 2010

(54) Catching device

(76) Inventor: Thomas Haugen, Newport, FL (US)

Correspondence Address: WILEY HORTON, 215 SOUTH MONROE STREET, 2ND FLOOR, TALLAHASSEE, FL, 32301, US

(21) Appl. No.: 12/456,379

(22) Filed: Jun. 16, 2009

(51) Int. Cl. A01K 69/10; A01K 69/06

(52) U.S. Cl. 43/102; 43/105; 43/100

(57) ABSTRACT

A catching device for which a user can trap a fish in a body of water, wherein said catching device is generally comprised of a first side wall, a second side wall, a top, a bottom, an entrance opening and an exit opening. First side wall, second side wall, top and bottom form a frame which has a hollow interior. Entrance opening and exit opening form conduits between the body of water and the interior of the excluding device. The width of entrance opening is equal to the width of exit opening. Entrance opening and exit opening are surrounded by two excluding bars attached to two excluding plates such that the excluding plates define the maximum expandable width of entrance opening and exit opening. The maximum expandable width of entrance opening is greater than the maximum expandable width of exit opening. A plurality of ballast chambers are attached to the present device. The present catching device also contains a plurality of escape holes and at least two release doors set to open after prolonged exposure to water.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of devices made for fishing. More specifically, the invention comprises a fish catching device which catches a specific size or shape of fish.

2. Description of the Related Art

Presently, commercial and recreational fishermen are subject to many restrictions on both the size and type of fish that can be caught. Sport fishermen or recreational fishermen commonly use a reel, rod, line, hooks and various baits. These fishermen regulate their catch by throwing the fish back into the water if the catch is too small, too big or of an undesirable species. Oftentimes these fish do not live due to internal injuries related to decompression and hook removal.

Similarly long line fishing, common to commercial fishermen, involves the use of baited hooks attached at intervals to a line, sometimes several miles long. They also discard undesirable species and fish that are too small resulting in mortality of juvenile fish.

The Gulf of Mexico Fishing Counsel determined in 2009 that the use of hooks in both recreational and commercial fishing was related to a decrease in sea turtle population.

Fish pots also known as traps, are also used by commercial fishermen to catch a variety of fish and crustaceans for consumption. Most pots are made from a metal wire or nylon web stretched over a steel frame. These pots have one or more openings called funnels which taper into the inside of the pot. Generally, when a fish enters the pot the funnel bends slightly allowing access. Once the fish is inside, the funnel returns back to its original narrowness preventing the fish from escape. Even though escape holes can be put in the sides of these pots to allow some smaller fish to escape, many juvenile fish are still caught and must be discarded. Present day fish pots use biodegradable escape panels which fall off after one or more months allowing fish or crabs to escape.

Some common recreational and commercially caught fish species are protogynous hermaphroditic. These fish only produce a reproductive male when a candidate is of an older age or a larger size. With regards to these species, it would prove to be an invaluable management tool, if a harvest method were developed that would exclude the catching and resulting mortality of these larger fish.

Therefore what is needed is a catching device which does not use hooks, thus eliminating sea turtle and seabird mortality. A catching device which eliminates all mortality associated with discards by excluding all of the smaller forage fish and all of the juvenile targeted species, and a device that could when needed, be set up to exclude all of the larger fish, allowing the protogynous hermaphroditic varieties to complete their reproductive cycle. In the event that this device is lost at sea it must be fitted with escape hatches which are accessible no matter what position the device is located and these hatches must open predictably in a predetermined number of days not months. The present invention achieves these objectives, as well as others that are explained in the following description.

### BRIEF SUMMARY OF THE INVENTION

The present invention comprises a catching device which is generally comprised of a top, first side wall, second side wall, bottom, entrance opening and exit opening. The present catching device allows a user to trap a particularly sized range of fish. First side wall, second side wall, top and bottom form a frame which has a hollow interior. Entrance opening and exit opening form conduits between the body of water and the interior of the catching device. The width of entrance opening is the same as the width of exit opening. Entrance opening and exit opening are surrounded by two excluding bars attached to two excluding plates such that the excluding plates set the excluding bars a specific distance apart. The first side wall and second side wall sit inside of the excluding bars. The excluding bars form a maximum expandable width of entrance and exit openings. The present catching device also contains a plurality of escape holes and at least two release doors set to open after prolonged exposure to water.

The difference in the maximum expandable widths of entrance opening and exit opening determines the size of fish that will be caught by the present catching device. Those fish which are smaller than the maximum expandable width of exit opening will swim out of the catching device while those fish larger than the maximum expandable width of entrance opening will not be able to enter the interior of catching device. It is in this manner that a specific range of size of fish can be captured by the present catching device. Additionally, different profiles can be set by the excluding bars by the addition of profile shields, thus creating a maximum expandable profile of entrance opening and exit opening. It is in this manner that a specific range of shape of fish can be captured by the present catching device.

### BRIEF DESCRIPTION OF THE SEVERAL VIEWS OF THE DRAWINGS

FIG. 1 is a perspective view, showing the present invention.

FIG. 2 is a perspective view, showing the present invention.

FIG. 3 is a perspective view, showing the attachment of excluding plates to bars.

FIG. 4A is a perspective view, showing a detailed view of the exit opening.

FIG. 4B is a perspective view, showing a detailed view of the entrance opening.

FIG. 5 is a schematic view, showing the present invention from above.

FIG. 6 is a perspective view, showing the sidewall of the present invention.

FIG. 7 is a perspective view, showing galvanic time release and hooks attached to sidewall of the present invention.

FIG. 8 is a perspective view, showing sidewall with release door opened.

FIG. 9 is a perspective view, showing the present invention in a body of water.

FIG. 10 is a perspective view, showing the present invention being pulled out from a body of water.

FIG. 11 is a perspective view, showing an alternate embodiment of the present invention.

FIG. 12 is a schematic view, showing an alternate embodiment of the present invention.

FIG. 13 is a section view, showing the ballast chamber of the present invention.

### REFERENCE NUMERALS IN THE DRAWINGS

| | | | |
|---|---|---|---|
| 10 | present catching device | 12 | top |
| 14 | first side wall | 16 | second side wall |
| 18 | bottom | 20 | excluder bar |
| 22 | outer nuts | 24 | excluder plate |
| 26 | small escape hole | 28 | exit |
| 30 | release door opening | 32 | release door |
| 34 | entrance | 36 | galvanic time release |
| 38 | jute string | 40 | clip |
| | | 44 | bolt hole |
| 46 | securing nuts | 48 | interior |
| 50 | ocean floor | 52 | pot warp line |
| 54 | boat | 56 | pot hauler |
| 58 | third side wall | 60 | alternate exits |
| 62 | alternate entries | 64 | bait cup |
| 66 | profile shields | 68 | ballast chambers |
| 70 | coupler | 72 | PVC pipe |
| 74 | floats | 76 | bolts |
| 78 | lead | | |

### DETAILED DESCRIPTION OF THE INVENTION

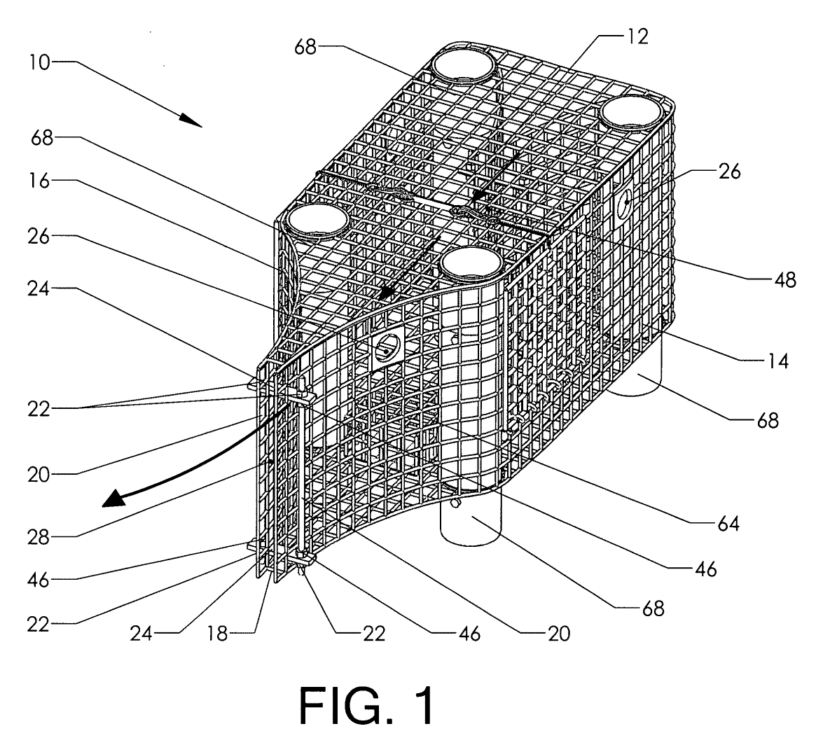

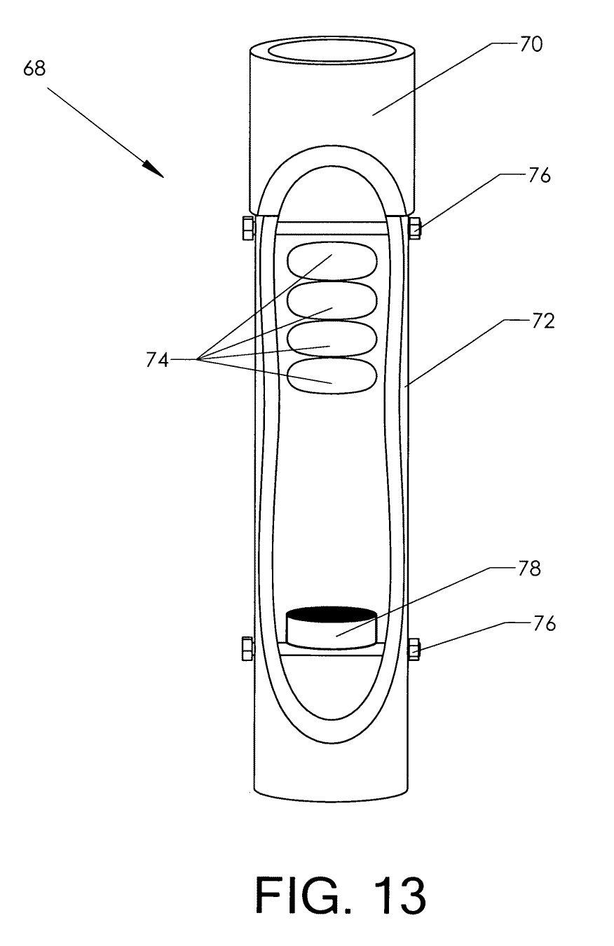

FIG. 1 illustrates the present invention in the preferred embodiment. The present catching device 10 is generally comprised of a top 12, first side wall 14, second side wall 16, bottom 18, entry 34, exit 28, excluder bars 20 and excluding plates 24. The frame of the present catching device 10 is formed by top 12, first side wall 14, second side wall 16, and bottom 18. Present catching device 10 is preferably made primarily from vinyl coated wire; however, any semi-malleable, water-permeable material could be used. As shown in FIG. 1, the present device is fully enclosed except for entry 34 and exit 28. Exit 28 is shown in FIG. 1, formed by top 12, first side wall 14, second side wall 16 and bottom 18. On either side of exit 28, outside of first side wall 14 and second side wall 16 are two excluder bars 20 which run the height of exit 28. Excluding plates 22, 24 attach to each excluder bar 20, held in place by outer nuts 22 and securing nuts 46, which fix excluder bars 20 apart from one another at a specific distance. Excluding plates 22, 24 pass through first and second side wall 14, 16 at exit 28 and are located between top 12 and bottom 18. Excluder bars 20 dictate the maximum expandable size of exit 28 by keeping first and second side walls 14, 16 from expanding wider than excluder bars 20. As a fish swims through entry 34, the fish is able to push apart first side wall 14 and second side wall 16 to fit through. However, if a fish is larger than the width of the excluder bars 20, the fish will be prevented from entering the present catching device 10. In the preferred embodiment, four ballast chambers 68 are attached to each corner of the invention. Ballast chambers 68 are further described in FIG. 13, however, the reader will appreciate that as the present catching device 10 is lowered in the water, ballast chambers 68 allows the buoyancy of present catching device 10 to be adjusted to regulate the underwater weight of the present catching device 10. This function allows minimum contact and destruction with the fragile ocean floor, while eliminating lobster and crab by-catch. Additionally, ballast chambers 68 act to keep the present catching device 10 in an upright position, ultimately ensuring proper orientation when the present catching device 10 comes to rest. Ballast chambers 68 contain coupler 70 (shown in FIG. 13), in order to allow present catching device 10 to stack onto a second catching device. Thus, coupler 70 (shown in FIG. 13) preferably has a diameter that is slightly larger than the diameter of the bottom of ballast chamber 68. The reader will appreciate that any number of catching devices can be stacked and interconnected to one another.

First side wall 14 and second side wall 16 contain a number of fish escape holes 26. While the preferred embodiment shows four fish escape holes 26, the reader will appreciate that any number and/or size of fish escape holes 26 can be incorporated into the present catching device 10. Additionally, an optional bait cup 64 is shown on bottom 18 of present catching device 10 protruding upward into interior 48 of present catching device 10. Bait cup 64 is accessible from the exterior of the present catching device 10. It is in this manner that the user can load bait into bait cup 64 thereby attracting fish to the interior of the present catching device 10.

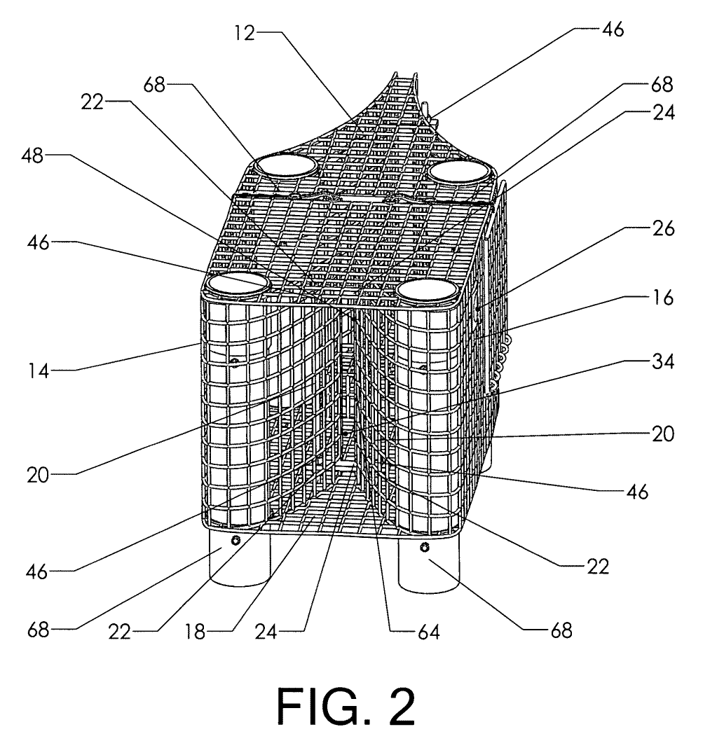

FIG. 2 shows a perspective view of entrance 34. Similar to exit 28 (shown in FIG. 1), entrance 34 is formed by top 12, first and second side walls 14, 16, and bottom 18. First and second side walls 14, 16 curve together to form a funnel towards interior 48 of present catching device 10. Excluding plates 22, 24, which travel through first and second side wall 14, 16, attach to excluder bars 20 by way of outer nuts 22 and securing nuts 46.

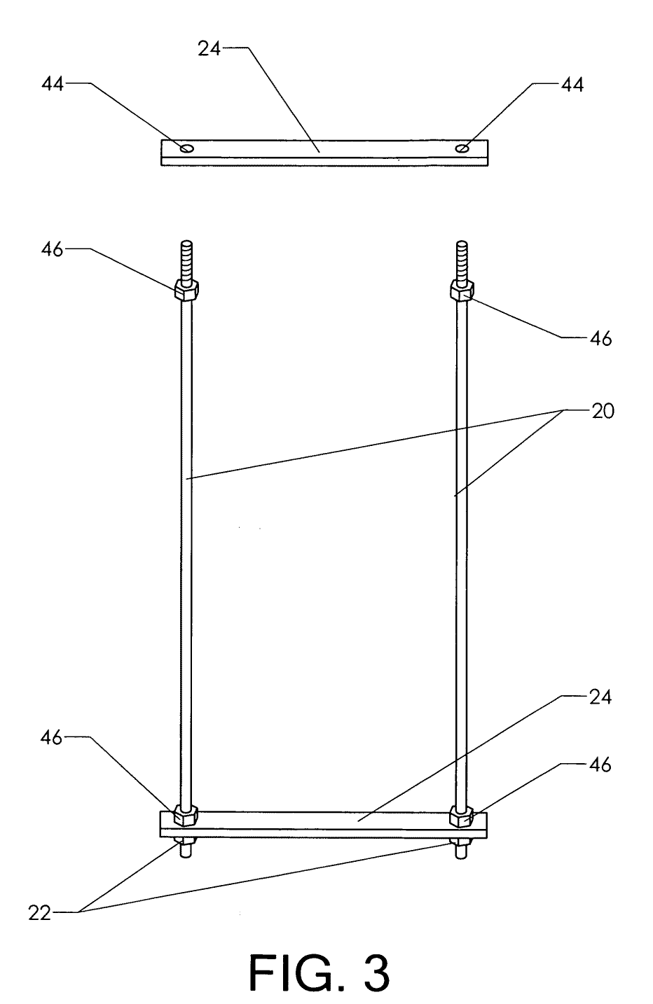

FIG. 3 shows the excluder bars 20, excluding plates 24 and nuts 22 assembled. Each excluding plate 22 includes two bolt holes 44. Two securing bolts 46 are screwed onto each excluder bar 20 prior to installing excluding plates 24. Once securing bolts 46 are in place each excluding plate 24 is placed over excluder bars 20 at bolt holes 44. The distance between the two bolt holes 44 determines the specific distance that excluder bars 20 are set apart. The reader will appreciate that different sized excluding plates 24 can be changed out relatively easily allowing the user to set the bars at different distances apart from each other by simply changing the excluding plates 24. Once excluding plates 24 are attached to excluder bars 20 the remaining outer nuts 22 are screwed onto excluder bars 20 to hold excluding plates 24 in place. However, one skilled in the art will recognize that excluding plates 22, 24 and excluder bars 20 could be held together in any manner, including being welded together to form one integrated unit.

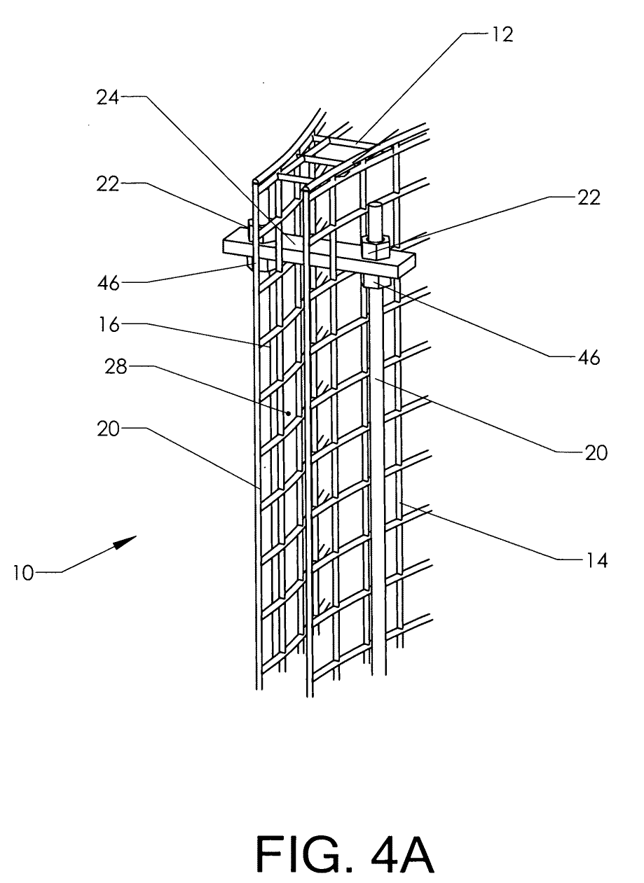

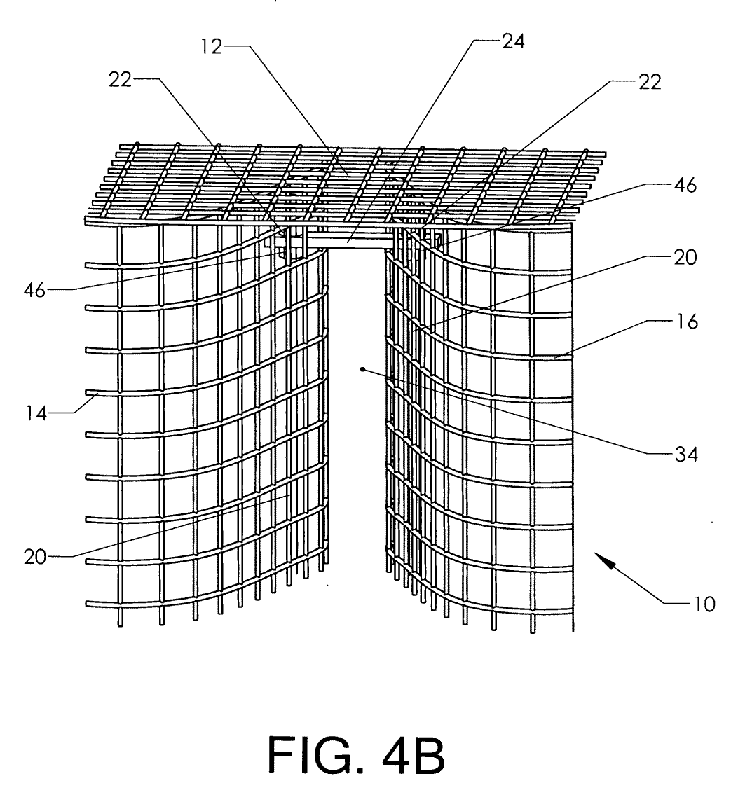

FIGS. 4A and 4B show the placement of excluding plates 24 onto the present catching device 10 at exit 28 and entrance 34. In FIG. 4A, exit 28 is shown defined by first side wall 14 and second side wall 16. Excluding plate 24 passes through both first side wall 14 and second side wall 16 prior to attaching to excluder bars 20. Top 12 is located above excluding plate 24, however, excluder bars 20 could extend through top 12 and excluding plate 24 placed above top 12. Similarly, as shown in FIG. 4B, entrance 34 is shown formed by first side wall 14 and second side wall 16. Excluding plate 24 passes through first side wall 14 and second side wall 16. The reader will observe that while excluder bars 20 do not determine the unexpanded width of entrance 34 or exit 28, excluder bars 20 do determine the maximum expanded width of both entrance 34 and exit 28.

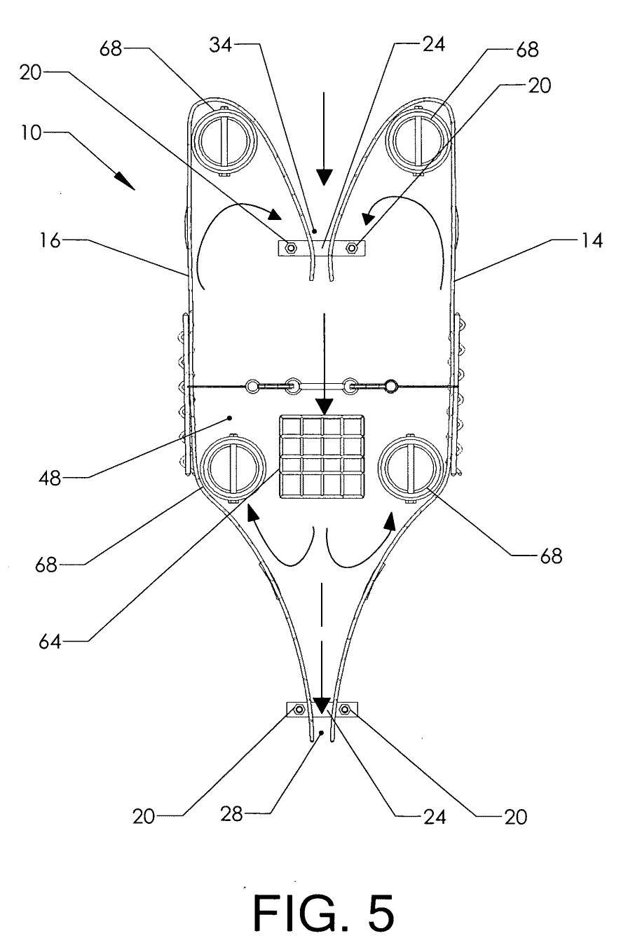

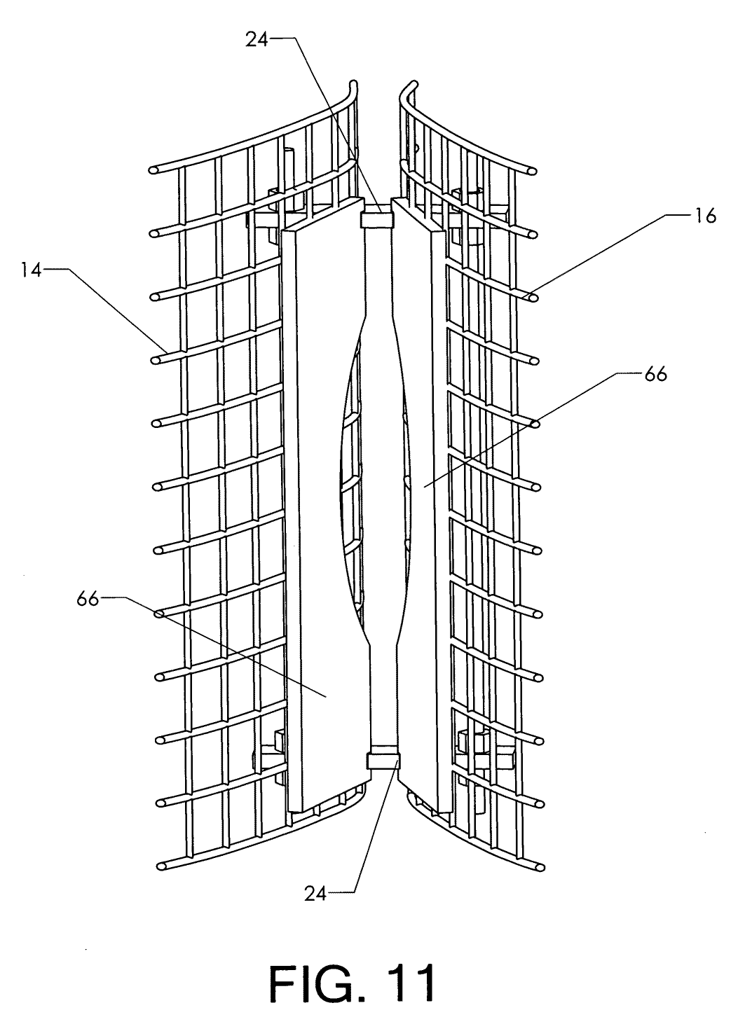

FIG. 5 is a schematic view which shows a view from the top of the present catching device 10. Entrance 34 and exit 28 are the same width. However, the width between excluder bars 20 at entrance 34 is larger than the width between excluder bars 20 at exit 28. First side wall 14 and second side wall 16 taper in to form entrance 34, which funnels into interior 48 of the present catching device 10. As a fish swims through entrance 34, first side wall 14 and second side wall 16 would naturally expand to allow the fish to enter. As long as the fish was smaller than the maximum expandable entrance, or width of the excluder bars 20 the fish would enter into present catching device 10. Once inside the interior 48 of the present catching device 10 the fish would naturally swim towards exit 28. If the fish is too large to fit through the width that the excluder bars 20 are set apart, just outside of exit 28, the fish would cycle throughout interior 48, as shown by the arrows in FIG. 5. The difference in size between the width of the excluder bars 20 outside of entrance 34 and the width of excluder bars 20 outside of exit 28 allows the user to capture a fish that is not too small and not too big. Depending on the desired size ratio a user could change the width of excluder bars 20 around entrance 34 and exit 28 in order to capture a particular size group of fish. Alternatively, as shown in FIG. 11, profile shields 66 can be placed inside or outside of first side wall 14 and second side wall 16, allowing the user to capture a particular shape of fish, as described below.

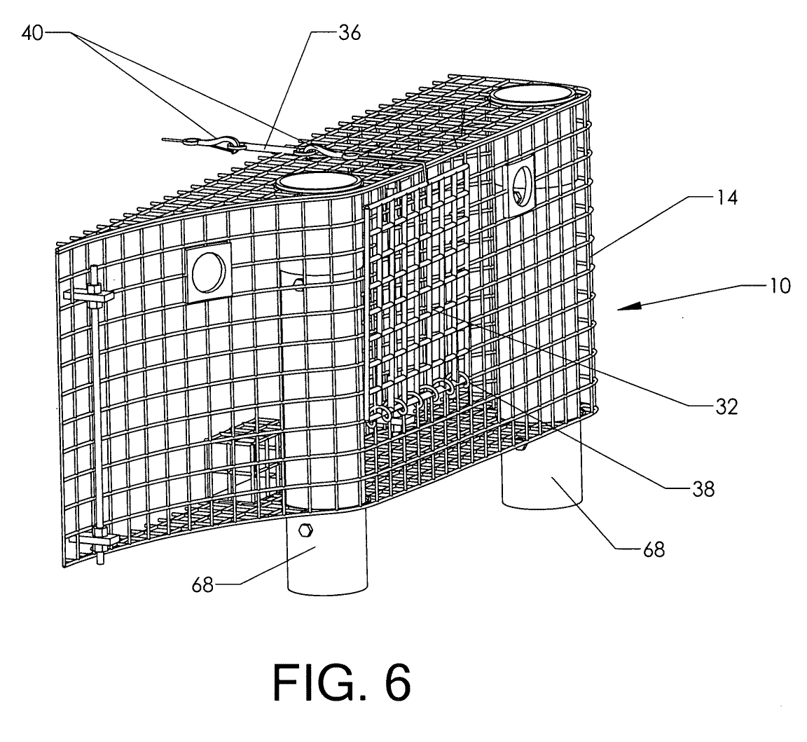

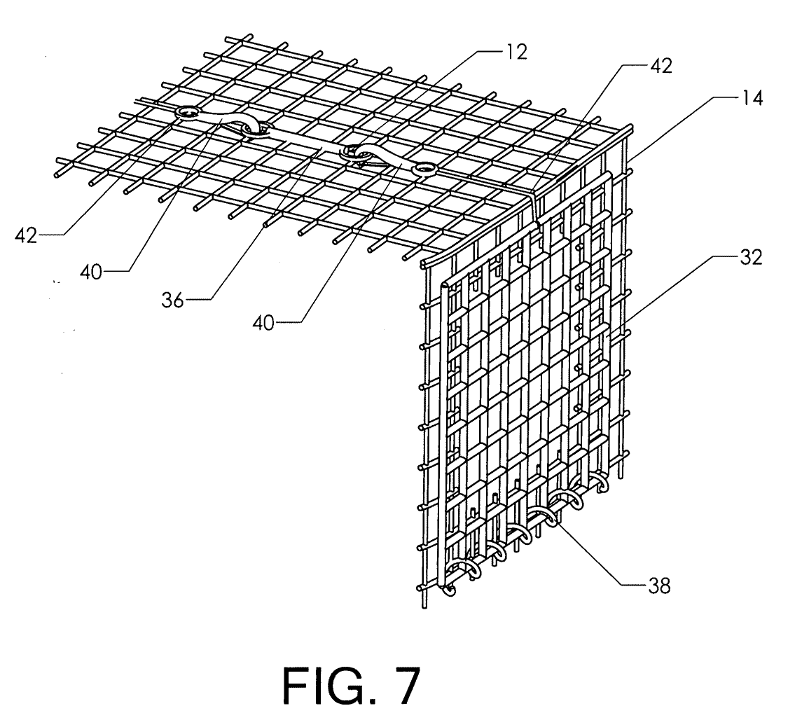

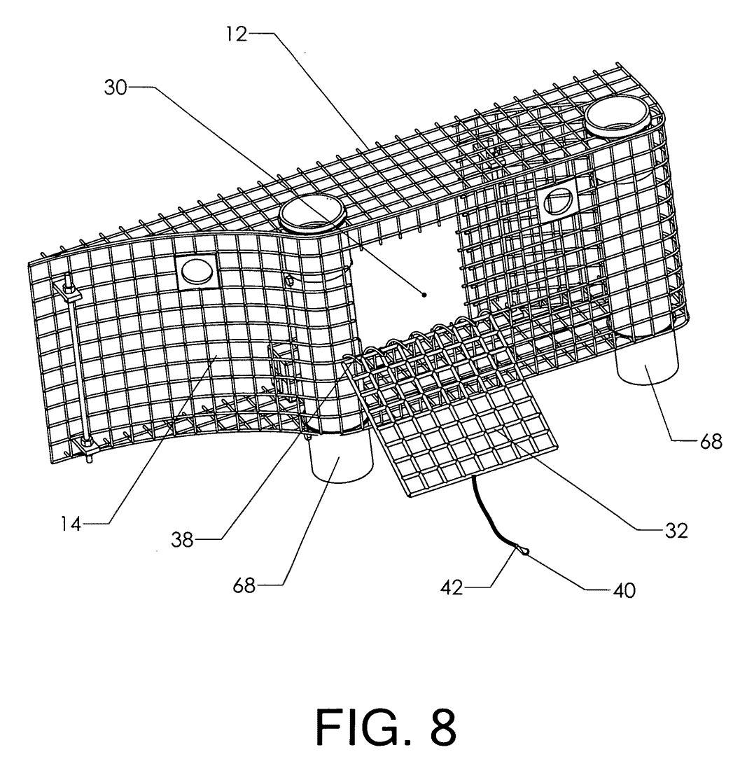

FIG. 6 shows the location of release door 32 on first side wall 14. Two release doors 32 are opposite one another on the present catching device 10. FIG. 7 shows a more detailed view of the manner in which release door 32 is held to other release door 32. Galvanic time releases 36 are devices which corrode relatively quickly when exposed to water. In the present device the galvanic time release 36 is used to allow release doors 32 to open in the event that the present device is lost at sea. Clips 40 are attached at one end to galvanic time release 36. The other end of clips 40 are attached to opposite release doors 32. In the event that the present device is lost at sea galvanic time release 36 will corrode in the fixed period of time and open the release door 32, shown in FIG. 8, allowing sea life to pass freely through the device. Jute strings 38 are used to tie the lower part of release door 32. Jute strings 38 are preferably biodegradable as added security of release door 32 opening after a long period of time underwater.

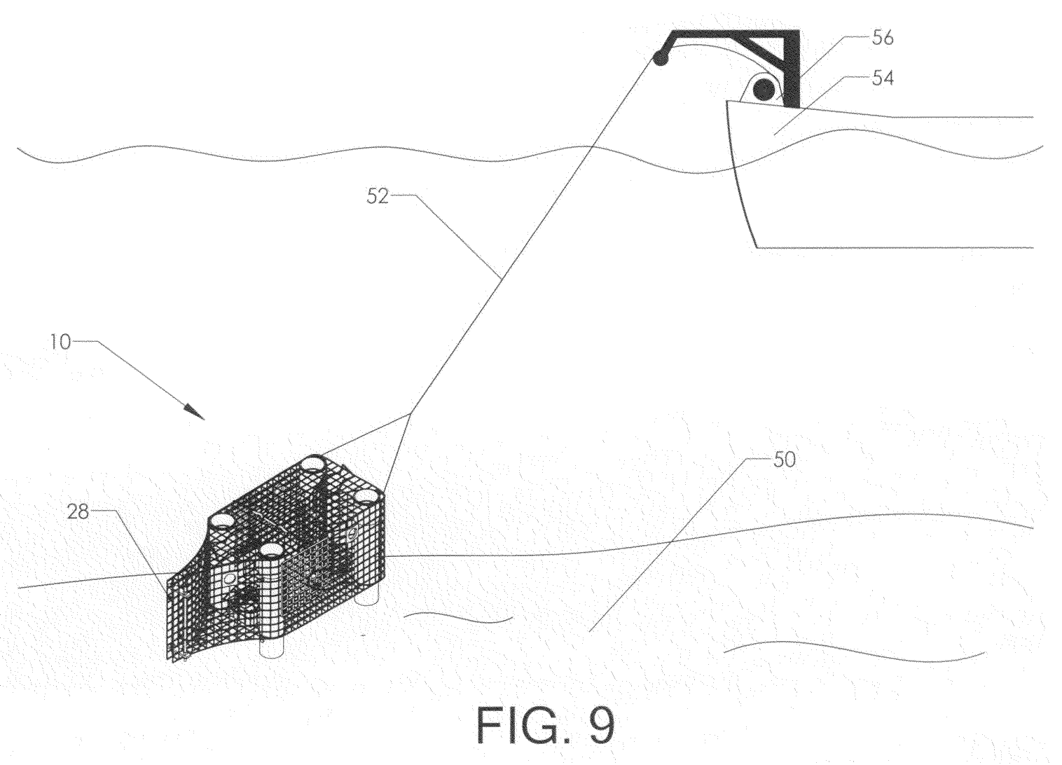

The illustration in FIG. 9 portrays how the present catching device 10 sits on ocean floor 50 attached to pot hauler 56 and boat 54 by pot warp line 52. As the present catching device 10 sits on the ocean floor 50, very small fish can freely swim in and out of present catching device 10. However, fish larger than the maximum expanded width of entrance 34 are unable to swim into the present catching device 10 at all.

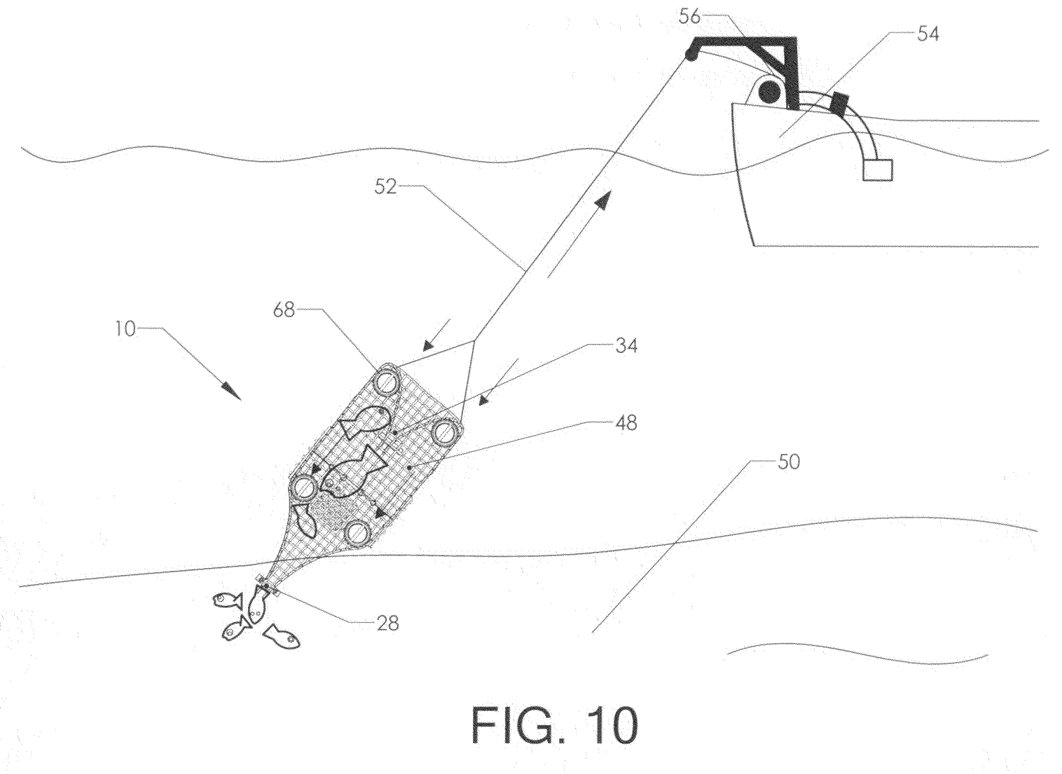

FIG. 10 shows how present catching device 10 operates to funnel the fish out of device while being lifted off of the ocean floor 50. Pot warp line 52 is attached to two points on present catching device 10 on both sides of entrance 34. The other end of pot warp line 52 is attached to a pot hauler 56. Pot hauler 56 retracts pot warp line 52. Pot hauler 56 can be programmed with an assent control device to retract pot warp line 52 and the present catching device 10 at a specified rate with several pre-programmed stops at specified depths. The function of the pot hauler 56 allows the user to slowly depressurize the fish preventing internal bodily damage created by surfacing too quickly. Pot warp line 52 pulls present catching device 10 towards the stern of the boat 54 with entrance 34 advancing toward the boat 54 first. As present catching device 10 moves upward through the water, the water passes through present catching device 10 creating a consistent flow of water directing the fish towards exit 28. It is in this manner that the device acts like a funnel and the hydrodynamic force, forces fish smaller than the maximum expanded width of exit 28 to leave interior 48 of present catching device 10.

FIG. 11 illustrates an alternate embodiment of the present invention. In the alternate embodiment profile shields 66 are set either parallel to or angled away from excluder plates 24. Profile shields 66 expand as fish swims through allowing first side wall 14 and second side wall 16 to expand. By placing different sized profile shields 66 at entrance and exit (not shown) the user can catch a group of fish with a particular profile.

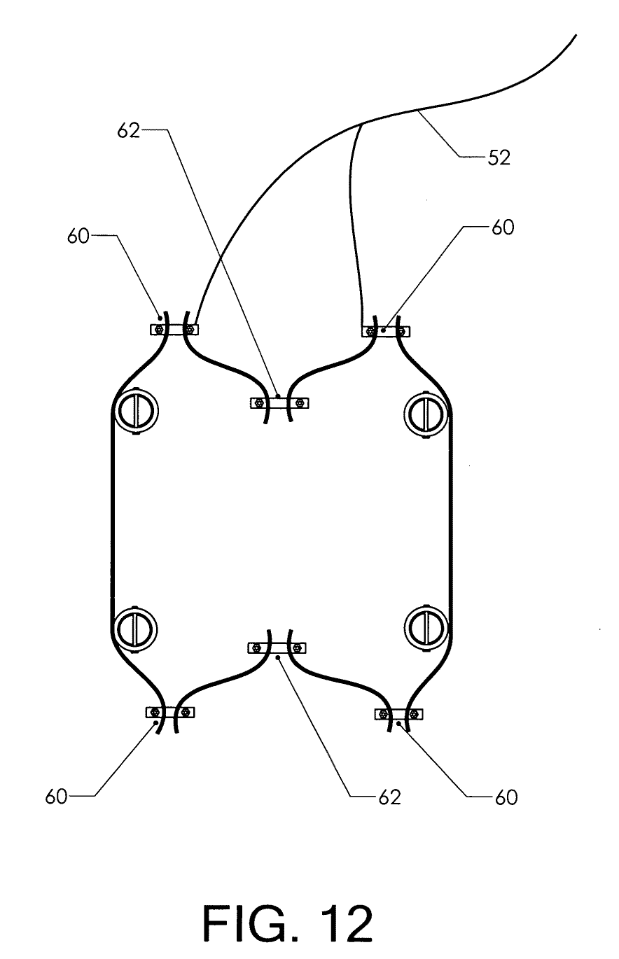

FIG. 12 shows a schematic view of the alternate embodiment of the present invention. In the alternate embodiment there are two entries 62 and four exits 60. The reader will observe that any number of exits and entries can be added to the present device. The function of the alternate embodiment is very similar to the preferred embodiment, in that the fish are forced towards alternate exits 60 as the device is pulled through the water.

In FIG. 13 the inside of a ballast chamber 68 is shown. Ballast chamber 68 is preferably made up of a PVC pipe 72, with coupler 70 at the top of ballast chamber 68 to allow the base of the PVC pipe 72 to fit into top 70 of ballast chamber 68. Coupler 70 is preferably a PVC pipe coupler. Lead 78 sits in the base of each ballast chamber 68 causing ballast chamber 68 to sink while floats 74 are located in the top portion of each ballast chamber 68 designed to keep the ballast chamber 68 upright and maintain the desired amount of negative buoyancy. Additionally, ballast chamber 68 protrudes past the bottom of the device to suspend the device over the fragile ocean bottom (or body of water bottom) while eliminating crustacean and shellfish by-catch.

The preceding description contains significant detail regarding the novel aspects of the present invention. It should not be construed, however, as limiting the scope of the invention but rather as providing illustrations of the preferred embodiments of the invention. As an example, additional entries and exits can be added to the present invention. Additionally, release door 32 could be held in place on sidewall by a number of different means. Thus, the scope of the invention should be fixed by the following claims, rather than by the examples given.

I claim:

1. A catching device for which a user can trap a fish, wherein said catching device has an exterior, said catching device comprising:
a. a first side wall;
b. a second side wall;
c. a top, attached to said first side wall and said second side wall;
d. a bottom, attached to said first side wall and said second side wall;
e. wherein said first side wall, said second side wall, said top and said bottom form said catching device such that said catching device has an interior;
f. an entrance, having a width, formed by said first sidewall, said second sidewall, said top and said bottom such that said entrance forms a conduit from said exterior into said interior;
g. an exit, having a width, formed by said at least two sidewalls, said top and said bottom such that said exit forms a conduit from said interior to said exterior; and
h. wherein said width of said entrance is equal to said width of said exit.

2. A catching device as recited in claim 1, wherein said entrance further comprises:
a. at least two excluding bars proximate to said entrance;
b. at least two excluding plates attached to said at least two excluding bars such that at least two excluding bars are positioned apart at a set distance; and
c. wherein said set distance of said at least two excluding bars provides a maximum expandable width of said entrance.

3. A catching device as recited in claim 2, wherein said exit further comprises:
a. at least two excluding bars proximate to said exit;
b. at least two excluding plates attached to said at least two excluding bars such that at least two excluding bars are positioned apart at a set distance; and
c. wherein said set distance of said at least two excluding bars provides a maximum expandable width of said exit.

4. A catching device as recited in claim 3, wherein said maximum expandable width of said entrance is greater than said maximum expandable width of said exit.

5. A catching device as recited in claim 4, further comprising at least one escape hole attached to said first side wall.

6. A catching device as recited in claim 5, further comprising a first release door attached to said first side wall and a second release door attached to said second side wall.

7. A catching device as recited in claim 6, wherein said first release door and said second release door are attached to said first side wall and said second side wall by a plurality of biodegradable jute string ties.

8. A catching device as recited in claim 6, wherein said first release door is attached to said second release door by a galvanic time release device.

9. A catching device as recited in claim 4, further comprising a pot warp line having a first end and a second end, wherein said first end of said pot warp line is attached to said first side wall and said second side wall proximate said entrance of said catching device; and wherein said pot warp line is attached to a pot hauler at said second end.

10. A catching device as recited in claim 1, wherein said entrance and said exit further comprise a plurality of profile shields proximate said entrance and said exit such that said plurality of profile shields prevents said entrance and said exit from expanding beyond said plurality of profile shields.

11. A catching device for which a user can catch a fish, wherein said catching device is for use in a body of water, said catching device comprising:
a. at least two side walls;
b. a top, attached to said at least two side walls;
c. a bottom, attached to said at least two side walls;
d. wherein said at least two side walls, said top and said bottom form a frame containing an entrance opening having a width and an exit opening having a width; and
e. wherein said width of said entrance is equal to said width of said exit.

12. A catching device as recited in claim 11, wherein said entrance opening further comprises:
a. at least two excluding bars proximate to said entrance opening;
b. at least two excluding plates attached to said at least two excluding bars such that at least two excluding bars are positioned apart at a set distance; and
c. wherein said set distance of said at least two excluding bars provides a maximum expandable width of said entrance opening.

13. A catching device as recited in claim 12, wherein said exit opening further comprises:
a. at least two excluding bars proximate to said exit opening;
b. at least two excluding plates attached to said at least two excluding bars such that at least two excluding bars are positioned apart at a set distance; and
c. wherein said set distance of said at least two excluding bars provides a maximum expandable width of said exit opening.

14. A catching device as recited in claim 13, wherein said maximum expandable width of said entrance opening is greater than said maximum expandable width of said exit opening.

15. A catching device as recited in claim 14, wherein said catching device is configured such that when said catching device is pulled through said body of water said fish are forced towards said exit opening.

16. A catching device as recited in claim 15, further comprising at least two escape hole positioned on said at least two side walls.

17. A catching device as recited in claim 16, further comprising at least two release doors attached to said at least two side walls.

18. A catching device as recited in claim 17, further comprising a pot warp line having a first end and a second end, wherein said first end of said pot warp line is attached to said first side wall and said second side wall proximate said entrance opening of said excluding device; and wherein said pot warp line is attached to a pot hauler at said second end.

19. A catching device as recited in claim 18, wherein said pot hauler further comprises, a programmable function which allows said user to set said pot hauler to retract said pot warp line at a set speed with a series of set stops such that said excluding device bring said fish to the surface of said body of water depressurized.

20. A catching device as recited in claim 14, further comprising a plurality of ballast chambers attached to said at least two sidewalls such that said plurality of ballast chambers are configured to allow said catching device's buoyancy to be regulated.

21. A catching device as recited in claim 20, further comprising a coupler attached to said plurality of ballast chambers such that a second catching device can attach to said catching device at said coupler.

22. A catching device for which a user can catch a fish, wherein said catching device is for use in a body of water, said catching device comprising:
a. at least two side walls;
b. a top, attached to said at least two side walls;
c. a bottom, attached to said at least two side walls;
d. wherein said at least two side walls, said top and said bottom form a frame containing a plurality of entrance openings having a width and a plurality of exit openings having a width;
e. wherein said width of said entrance is equal to said width of said exit in a relaxed state;
f. wherein said plurality of entrance openings include:
i. a plurality of excluding bars proximate to said plurality of said entrance openings;
ii. wherein said plurality of excluding bars are positioned apart at a set distance;
iii. wherein said set distance of said plurality of excluding bars provides a maximum expandable width of said plurality of entrance openings;
g. wherein said plurality of exit openings include:
i. a plurality of excluding bars proximate to said plurality of said exit openings;
ii. wherein said plurality of excluding bars are positioned apart at a set distance;
iii. wherein said set distance of said plurality of said excluding bars provides a maximum expandable width of said plurality of exit openings; and
h. wherein said maximum expandable widths of said plurality of entrance openings are greater than said maximum expandable widths of said plurality of exit openings.
